(19) United States
(12) Patent Application Publication
(10) Pub. No.: US 2002/0160147 A1
(43) Pub. Date: Oct. 31, 2002

(54) Composite wood product and method of manufacture

(76) Inventors: Suezone Chow, Richmond (CA); Igor Zaturecky, Surrey (CA); Michael Chow, Richmond (CA); Isaac Chiu, Coqultlam (CA)

Correspondence Address: Charles H. Devoe, KOLISCH, HARTWELL, DICKINSON,, McCORMACK & HEUSER, 520 S.W. Yamhill Street, Suite 200, Portland, OR, 97204, US

(21) Appl. No.: 09/795,330

(22) Filed: Feb. 27, 2001

(51) Int. Cl. B32B 3/00; B27D 1/00; B27F 1/00; B27G 11/00; B32B 5/12

(52) U.S. Cl. 428/106; 428/60; 144/347

(57) ABSTRACT

A composite wood product manufactured from waney lumber and a method for making the composite wood product. The method utilizes lumber that has been cut from a log such that the piece has a length substantially parallel to the longitudinal axis, a width substantially tangential to the growth rings and a thickness substantially perpendicular to the growth rings. The wane on the lumber is removed to create a complementary side surface for joining in alternating growth ring orientation to the adjoining piece across the joined profiled side surfaces.

### FIELD OF THE INVENTION

This invention relates generally to a composite wood product and its method of manufacture. More particularly, this invention relates to a method for making a composite wood product from waney lumber and the composite wood product produced thereby.

### BACKGROUND OF THE INVENTION

The cylindrical shape of a log limits its utilization as commercially valuable lumber. In the process of manufacturing lumber, having a rectangular or square cross section, from a cylindrical log, some of the pieces will inevitably contain wane. Wane is a natural defect in which there is a lack of wood on one or more edges of a piece of lumber. Specifically, wane is a portion of the external surface of the cylindrical log that is left on the lumber. Wane, not only spoils the appearance of the lumber, but also reduces its basic strength because of its eccentricity and reduction of available bearing area. There is a need for methods that will permit waney lumber to be used more profitably.

A wide variety of innovative composite wood products are known. For example, U.S. Pat. No. 4,394,409 discloses a composite wood article made from triangular shaped log sections. U.S. Pat. Nos. 5,888,620 and 6,025,053 disclose a process for joining rectangular boards of a specific predetermined density to form a composite wood product. U.S. Pat. No. Re. 36,153 discloses the use of corner sections of lumber with a bracing means to form a composite wood product.

### SUMMARY OF THE INVENTION

According to a broad aspect, the invention provides a method of making a composite wood product. The method comprises joining complementary profiled side surfaces of two waney pieces of lumber, wherein each piece of lumber has been cut from a log, the log having growth rings concentrically arranged radially about a longitudinal axis of the log from an inner pith to an outer bark, so that the piece has a length substantially parallel to the longitudinal axis, a width substantially tangential to the growth rings and a thickness substantially perpendicular to the growth rings, with a top surface of the piece being towards the outer bark with respect to a bottom surface of the piece being towards the inner pith, the top surface and the bottom surface defining the thickness of the piece, and a left side surface and a right side surface defining the width of the piece, wherein at least one of the side surfaces of the piece is profiled to remove a wane to provide the complementary profiled side surface for joining; and, the pieces of lumber are joined in opposite orientation with the top surface of one piece adjacent to the bottom surface of the adjoining piece across the joined profiled side surfaces.

The invention also provides a composite wood product comprising at least two pieces of waney lumber joined at complementary profiled side surfaces, wherein the composite wood product comprises at least two pieces of lumber, wherein each piece of lumber has been cut from a log, the log having growth rings concentrically arranged radially about a longitudinal axis of the log from an inner pith to an outer bark, so that each piece has a length substantially parallel to the longitudinal axis, a width substantially tangential to the growth rings and a thickness substantially perpendicular to the growth rings, with a top surface of the piece being towards the outer bark with respect to a bottom surface of the piece being towards the inner pith, the top surface and the bottom surface of each piece defining the thickness of the piece, and a left side surface and a right side surface of each piece defining the width of the piece, wherein at least one of the side surfaces of each piece is profiled to remove a wane to provide the complementary profiled side surfaces for joining the pieces; and, the pieces of lumber are joined in opposite orientation with the top surface of one piece adjacent to the bottom surface of the adjoining piece across the joined profiled side surfaces.

The invention further provides a method of milling wood, comprising cutting a piece of lumber from a log, the log having growth rings concentrically arranged radially about a longitudinal axis of the log from an inner pith to an outer bark, so that the piece has a length substantially parallel to the longitudinal axis, a width substantially tangential to the growth rings and a thickness substantially perpendicular to the growth rings, with a top surface of the piece being towards the outer bark with respect to a bottom surface of the piece being towards the inner pith, the top surface and the bottom surface defining the thickness of the piece, and a left side of the piece and a right side of the piece defining the width of the piece, wherein at least one of the sides of the piece is profiled to remove a wane to provide a profiled side, and the profiled side comprises a series of right-angled steps disposed diagonally across the thickness of the piece.

Other aspects and features of the present invention will become apparent to those ordinarily skilled in the art upon review of the following description of specific embodiments to the invention in conjunction with the accompanying drawings.

### BRIEF DESCRIPTION OF THE DRAWINGS

FIG. 1 is a perspective view of a log showing the three major axes. “R” indicating the radial direction; “T” indicating the tangential direction; and “L” indicating the longitudinal direction;

FIG. 2 is a perspective view of a log showing the plain-sawn method of cutting lumber;

FIG. 3 is a perspective view of a log showing the quarter-sawn method of cutting lumber;

FIG. 4 is an end-view of a plain-sawn board showing cupping of the board;

FIG. 5 is an end-view of a quarter-sawn board;

FIG. 6 is a perspective view of a composite wood product according to the preferred embodiment of the present invention;

FIG. 7 is a transverse sectional view of a cylindrical log showing the general shapes of lumber produced from it;

FIG. 8 is a graphical illustration of the strength properties of the pine-alpine fir composite wood product.

### DETAILED DESCRIPTION

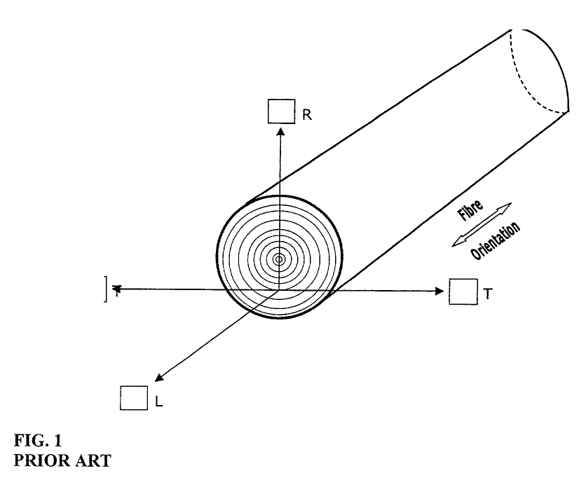

It is well known that wood is an anisotropic material in that its physical and mechanical properties vary with respect to three major axes in wood which extend in the longitudinal, radial, and tangential directions. As shown in FIG. 1, the longitudinal direction (“L”) is parallel to the length of the stem and is referred to as the fiber direction since the grain or fibers that make up the wood are oriented in this direction. The radial direction (“R”) is perpendicular to the growth rings and the tangential direction (“T”) is tangent to the growth rings and perpendicular to the radial direction.

The anisotropic character of wood is evident in the dimensional changes that result from the variation in moisture content (MC) of wood. In particular, the percentage of shrinkage of the wood is different along the three axes. Shrinkage along the grain, or longitudinal shrinkage, of normal wood from the green to the ovendry condition is, on average, small at about 0.1 to 0.2% (expressed as a percentage of the green dimension). Shrinkage across the grain, on the other hand, whether around the growth rings (tangential shrinkage) or across the growth rings (radial shrinkage) is substantial and can be 10 to 140 times the longitudinal shrinkage. Though shrinkage values vary widely among woods, tangential shrinkage averages about 8% and radial shrinkage about 4%. This directional swelling and shrinkage variation in wood induces internal stresses resulting in the bowing, crooking, twisting, cupping, and other forms of warpage commonly seen in lumber.

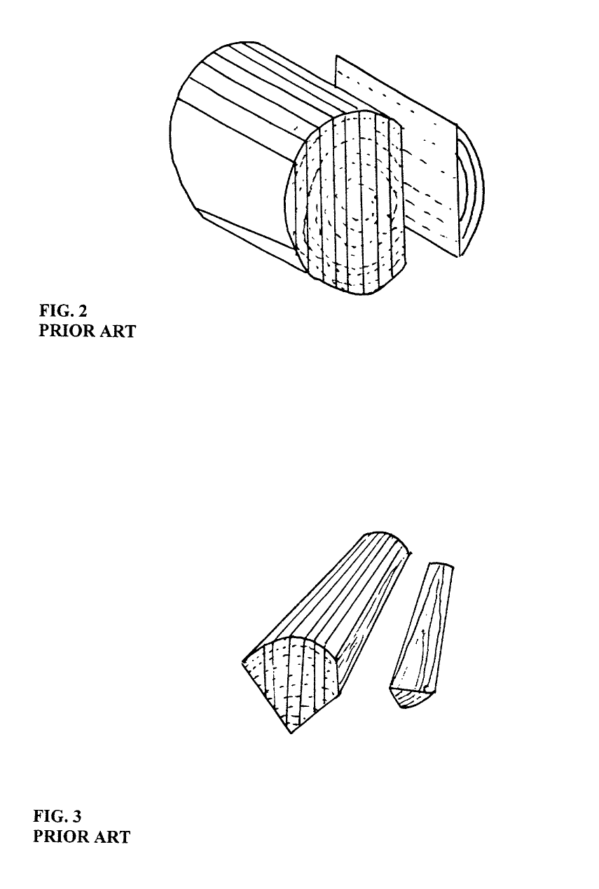

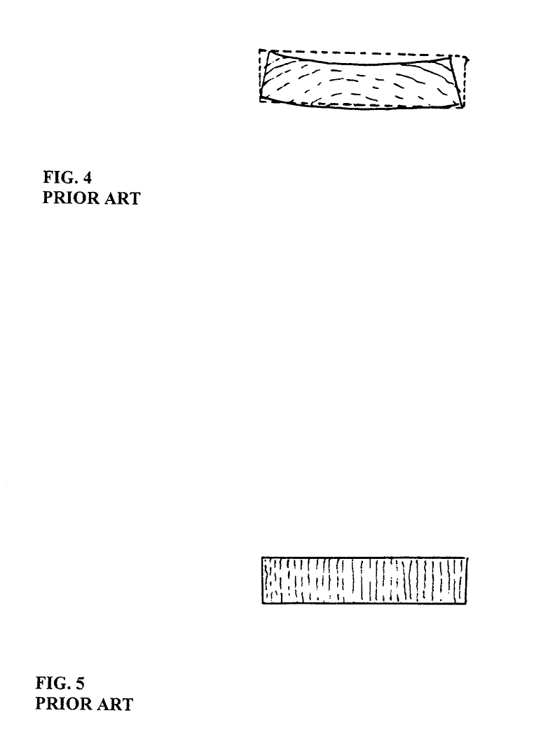

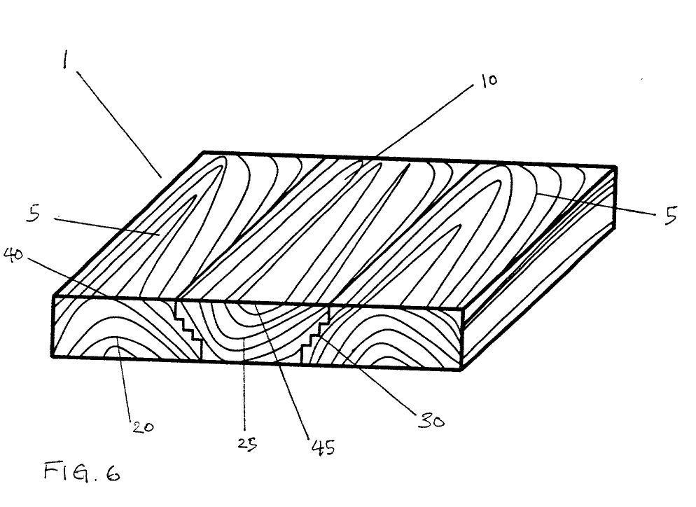

Lumber may be cut from a log in a number of ways. The two most common ways are the plain-sawn or flat-grained method and the quarter-sawn, or edge grained, or vertical grained method. As shown in FIG. 2, plain-sawn lumber is cut from a log such that the growth rings appear as approximately straight lines running across the grain of the board generally parallel to the board's face. On the other hand, quarter-sawn lumber, as shown in FIG. 3, is first cut into quarters, then into boards. As a result, in a quarter-sawn board, the lines formed by the growth rings run with the grain substantially vertical to the face of the board. Depending on the method of cutting, then, the orientation of the three axes in the board may vary. Moreover, the orientation of the three axes in the cut board will affect the differential shrinkage in the board. For example, as shown in FIGS. 4 and 5, the differential shrinkage in plain-sawn lumber results in the tendency of a plain-sawn board to have greater shrinkage through its width, compared to a quarter-sawn board, causing cupping across the width of the board (a distortion of a board in which there is a deviation from a straight line across the width of the board).

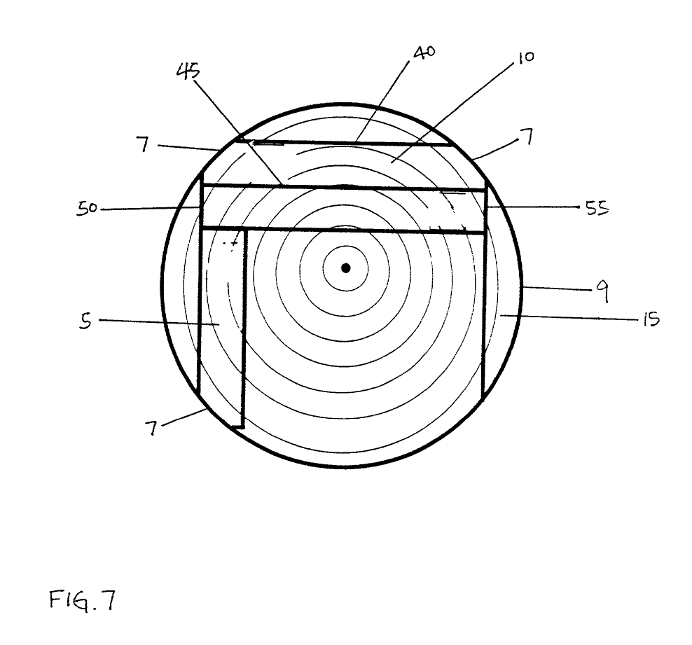

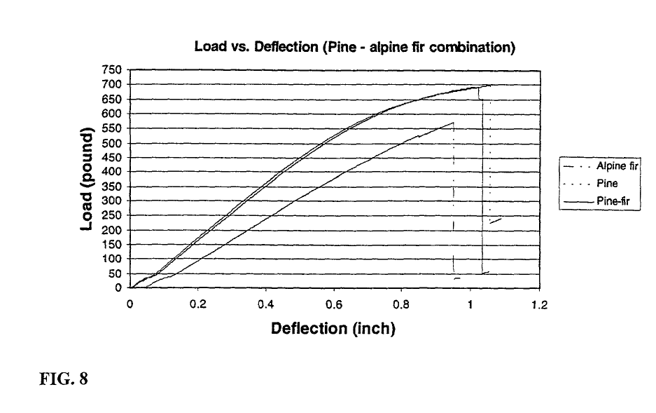

A composite wood product 1, as shown in FIG. 6, according to a preferred embodiment of the present invention comprises at least two pieces of waney lumber 5 and 10 joined together in a manner to be described. The present invention uses lumber that has been cut from a log such that the piece has a length substantially parallel to the longitudinal axis, a width substantially tangential to the growth rings and a thickness substantially perpendicular to the growth rings. For example, a width that is more tangential than radial is substantially tangential. As shown in FIG. 7, cutting lumber according to the preferred embodiment may result in lumber having a top surface 40 of the piece being towards the outer bark and the bottom surface 45 of the piece being towards the inner pith. In this way, the top surface 40 and the bottom surface 45 of the piece may define the thickness of the piece, and the left side surface 50 and the right side surface 55 of the piece may define the width. In one embodiment, the width of the piece may be greater than the thickness of the piece of waney lumber.

Depending on which area of the log the lumber is cut from, the lumber used in the present invention may have wane 7 on only one edge 5 or on both edges 10, as shown in FIG. 7. In some embodiments the lumber may be cut with a wane that is half-moon shaped 9. Where waney lumber having a half-moon shaped wane 15 is used, the curve side of the lumber may be planed flat to create a piece of wood having a two-sided wane.

The wane 7 on the piece of waney lumber 5 and 10 is removed to create a complementary profiled side surface 30 for joining. Removal of the wane may be performed by means of a computerized scanning system in series with an automatic profiling system. The scanning system scans the size and shape of the cross section of the waney lumber and determines the most appropriate angle and edge profile to be cut in removing the wane. The scanner communicates this information to the profiling system which, in turn, performs the edge profiling operation. Scanning of the lumber surface may be performed by systems known in the art such as an optical scanning technology, where a plane of light is generated onto the wood surface and a camera provides a profile image for estimating board thickness. The wane may then be removed to create a profiled side surface 30. The complementary side surface 30 may be profiled in a variety of shapes. In one embodiment, the complementary side surface 30 may be plane, cut diagonally to follow the general shape of the wane 7 so as to minimize wood waste. In another embodiment, the complementary profiled side surface 30 may be step-shaped as shown in FIG. 6.

Preferably, the waney lumber is profiled so that the profiled side surface 30 is rotationally complementary. By rotationally complementary it is meant that the profiled side surface would mate with itself when the piece of lumber is turned upside-down. The profiled pieces of lumber may then be joined side-by-side along the profiled side surfaces 30 in opposite orientation such that the top surface 40 of one piece is adjacent to the bottom surface 45 of the adjoining piece in the composite wood product 1. In some embodiments, as shown in FIG. 6, arrangement of the pieces of lumber 5 and 10 as described may result in an alternating orientation of the growth rings 20 and 25 of the pieces of lumber 5 and 10. This alternation of the growth ring orientation 20 and 25 may provide a natural means for balancing the internal stresses of the wood to minimize warpage of the composite wood product 1.

The elongated pieces of wood 5 and 10 are bonded together at the complementary profiled surfaces 30 to form the composite wood product 1. The pieces of wood 5 and 10 are bonded together preferably by an adhesive. The adhesive used may be selected from those adhesives known in the art such as a polyvinyl acetate adhesive or phenol-resorcinol formaldehyde adhesive.

In view of the natural dimensional stability imparted by the alternating growth ring orientation 20 and 25, it will be appreciated by a person of skill in the art that the present invention contemplates the use of a variety of waney wood qualities.

In one embodiment, elongated pieces of wood 5 and 10 having a moisture content (MC) greater than the normally used 12 to 15% may be used. In other embodiments, elongated pieces of wood 5 and 10 having an MC of up to 25% may be used.

In another embodiment, pieces of lumber 5 and 10 may be selected from more than one species of wood to produce a composite wood product 1 comprising a combination of wood species. In this way, stronger species of wood may be combined with weaker varieties. The elongated pieces of wood 5 and 10 may, for example, be selected from species having different strength characteristics such as spruce, pine, and fir. In one embodiment, the composite wood product 1 may comprise a combination of pine and alpine fir. In another embodiment, the composite wood product 1 may comprise a combination of white spruce and alpine fir.

It is further contemplated that the composite wood product 1 of the present invention may be used in the manufacture of larger composite products, such as laminated posts and beams.

### EXAMPLES

### Example 1

Availability of Lumber as Potential Raw Material for the New Processing Technology

A study was conducted to determine the availability of lumber to be used as raw material for the new processing method described above. A total of 290 pieces of Utility grade nominal 2×4-inch spruce-pine-fir (S-P-F) lumber was sampled from a regular sawmill. These pieces were inspected for wane and other defects. The results showed that about 25% of the lumber had one-sided wane, 33% had two-sided wane (FIG. 1), and 10% had a more or less half-moon shape (FIG. 7), giving a total of 68% available material of utility grade amenable to processing in accordance with various aspects of the invention.

### Example 2

Dimensional Stability of Edge-bonded Wood Composites Prepared with the New Processing Technology

An experiment was conducted to assess the warping properties of edge-bonded wood composite products made using the new processing technology. Five panel samples, 18 inches (457 mm) wide (across the grain)×60 inches (1,524 mm) long (along the grain), were prepared from nominal 1×6-inch (mill-run) dried waney spruce-pine-fir (S-P-F) lumber. Five similar panels were prepared from nominal 2×4-inch (combination of Utility and No. 3 grades) dried waney S-P-F lumber. The MC of the lumber used was 10 to 15%. A step-shaped profile was used to bond the lumber pieces edgewise using a catalyzed polyvinyl acetate adhesive. Pressing was done on an edge-bonding press. The panels were stored by hanging them vertically using two islet hooks attached from one end to allow them to move freely. The storage area had a temperature of 10° to 18° C. (average 13° C.) and a relative humidity of 56 to 75% (average 69%) throughout the test. After a week, the panels were turned 180° with respect to an axis parallel to the length to subject them to a similar air flow across both faces.

The warping (bow, cup and twist) of the panels was measured about three to six weeks after they were made at which time the average MC was then 13.5% as measured with a moisture meter. The results are shown in Table 1. For the 1.25-inch thick panels, the bow ranged form 0.1 to 1.0 mm (average 0.3 mm), cup 0.0 to 1.8 mm (average 0.5 mm), and twist 0.0 to 5.4 mm (average 2.1 mm ). For the 0.75-inch thick panels, the corresponding values were 0.0 to 0.7 mm (average 0.3 mm) for the bow, 0.3 to 2.7 mm (average 1.3 mm) for the cup, and 0.0 to 0.6 mm (average 0.2 mm) for twist. These data were all lower than the 6.4-mm maximum warping requirement as specified by the CAN/CSA standard for wood flush doors (1) and the 7-mm maximum warping requirement specified by the CSA standard for stile and rail wood doors (2). These results demonstrate the positive effect of the new processing technology in imparting dimensional stability to the edge-bonded composite product.

TABLE 1
Dimensional stability of a new edge-bonded wood composite.

| | | | |
|---|---|---|---|
| Sample No. | Bow (mm) | Cup (mm) | Twist (mm) |

Panel Thickness-1.25 inches

| | | | |
|---|---|---|---|
| 1 | 0.1 | 0.0 | 1.4 |
| 2 | 0.1 | 0.5 | 5.4 |
| 3 | 1.0 | 1.8 | 0.0 |
| 4 | 0.3 | 0.1 | 3.2 |
| 5 | 0.2 | 0.1 | 0.5 |
| Average | 0.3 | 0.5 | 2.1 |

Panel Thickness-0.75 inch

| | | | |
|---|---|---|---|
| 1 | 0.0 | 2.7 | 0.6 |
| 2 | 0.0 | 1.1 | 0.0 |
| 3 | 0.2 | 0.3 | 0.0 |
| 4 | 0.4 | 0.4 | 0.2 |
| 5 | 0.7 | 2.0 | 0.0 |
| Average | 0.3 | 1.3 | 0.2 |

### Example 3

Strength Properties of Edge-bonded Composite Products Consisting of Two Wood Species Combinations

An experiment was conducted to assess the strength properties, such as bending strength or modulus of rupture (MOR) and bending stiffness or modulus of elasticity (MOE), of edge-bonded composite products consisting of a combination of two wood species compared to those of the individual members making up the composite. Twenty edge-bonded samples were prepared from dried nominal 2×4-inch×8-foot lumber using phenol-resorcinol formaldehyde adhesive, half of which consisted of a combination of pine and alpine fir, and the other half a combination of white spruce and alpine fir. Three test specimens, approximately 5×1.25 inches (32 mm×32 mm) in cross section×31 inches (787 mm) in length, were prepared from each sample: one specimen (the composite) containing the edge joint located in the center, second a solid specimen (pine or spruce) cut from one side of the joint, and the third another solid specimen (alpine fir) cut from the other side of the joint. The solid specimens served as control. Half of the specimens were tested in such a way that the load was applied on the face containing the bondline, and the other half tested with the load applied on the face without the bondline. In the latter case, the specimens would be subjected to a horizontal shear force. For the composite specimens, the face with the higher volume of pine or spruce was positioned on the tension side for the test. Alpine fir is known to be the weakest among the three species in the S-P-F group (6). The solid samples were tested in such a way that the load was applied on the face nearest the pith.

Testing was carried out in an Instron machine. The specimen was loaded equally at two points equidistant from the reaction supports on a span length of 27 inches (686 mm). The two load points were located at a distance from their corresponding reaction supports equal to one-third of the span. The load was applied continuously at a rate of motion of the movable crosshead of 0.108 inch (2.7 mm)/min.

The results are shown in Tables 2 and 3 for the samples that were loaded on the face with the bondline. For the pine-alpine fir combination (Table 2) the results showed that, on the average, the solid alpine fir yielded the lowest MOR (7,721 psi), followed in increasing order, by the pine-alpine fir composite (8,879 psi) and the solid pine (9,344 psi). The corresponding average MOE for the solid alpine fir, pine-alpine fir composite and the solid pine were 1,389,000 psi, 1,688,400 psi, and 1,759,800 psi, respectively. The MOR of the solid alpine fir was 87.0% that of the pine-alpine fir composite, and that of the latter 95.0% that of the solid pine. For MOE, that of the solid alpine fir was 82.3% that of the pine-alpine fir composite, and that of the latter 95.9% that of the solid pine.

TABLE 2
Strength properties of edge-bonded pine-alpine fir composite
compared to its solid members (Loaded on face with bondline).

| | Specimen | Modulus of Rupture | Modulus of Elasticity |
|---|---|---|---|
| Material | Number | (psi) | (psi) |
| Alpine fir | 1 | 5,914 | 1,306,000 |
| (solid) | 2 | 8,463 | 1,424,000 |
| | 3 | 7,974 | 1,249,000 |
| | 4 | 9,420 | 1,562,000 |
| | 5 | 6,834 | 1,404,000 |
| | Average | 7721 | 1389000 |
| Pine | 1 | 10,590 | 1,652,000 |
| (solid) | 2 | 7,028 | 1,579,000 |
| | 3 | 9,994 | 1,725,000 |
| | 4 | 12,410 | 2,166,000 |
| | 5 | 6,696 | 1,677,000 |
| | Average | 9344 | 1759800 |
| Pine- | 1 | 7,315 | 1,634,000 |
| Alpine fir | 2 | 9,039 | 1,674,000 |
| (composite) | 3 | 9,491 | 1,622,000 |
| | 4 | 9,921 | 1,829,000 |
| | 5 | 8,628 | 1,683,000 |
| | Average | 8879 | 1688400 |

Similar results were obtained for the spruce-alpine fir combination (Table 3), i.e., the solid alpine fir gave the lowest average MOR (7,931 psi), followed in increasing order, by the spruce-alpine fir composite (9,789 psi) and the solid spruce (10,549 psi). The corresponding average MOE for the solid alpine fir, spruce-alpine fir composite, and the solid spruce were 1,335,600 psi, 1,693,600 psi, and 1,815,600 psi. The MOR of the solid alpine fir was 81.0% that of the spruce-alpine fir composite, and that of the latter 92.8% that of the solid spruce. for MOE, that of the solid alpine fir was 78.9% that of the spruce-alpine fir composite, and that of the latter was 93.3% that of the solid spruce.

TABLE 3
Strength properties of edge-bonded spruce-alpine fir composite
compared to its solid members (Loaded on face with bondline).

| | Specimen | Modulus of Rupture | Modulus of Elasticity |
|---|---|---|---|
| Material | Number | (psi) | (psi) |
| Alpine fir | 1 | 8,095 | 1,318,000 |
| (solid) | 2 | 8,489 | 1,206,000 |
| | 3 | 9,511 | 1,564,000 |
| | 4 | 6,282 | 1,055,000 |
| | 5 | 7,280 | 1,535,000 |
| | Average | 7931 | 1335600 |
| Spruce | 1 | 9,686 | 1,676,000 |
| (solid) | 2 | 7,971 | 1,446,000 |
| | 3 | 13,830 | 2,175,000 |
| | 4 | 10,200 | 2,069,000 |
| | 5 | 11,060 | 1,712,000 |
| | Average | 10549 | 1815600 |
| Spruce- | 1 | 7,252 | 1,478,000 |
| Alpine fir | 2 | 8,511 | 1,428,000 |
| (composite) | 3 | 11,990 | 2,033,000 |
| | 4 | 11,080 | 1,805,000 |
| | 5 | 10,110 | 1,724,000 |
| | Average | 9789 | 1693600 |

The results for the specimens that were loaded on the face without the bondline are given in table 4and 5. For pine-alpine fir combination (Table 4), the alpine fir solid again showed the lowest average MOR (6,523 psi), followed by the pine-alpine fir composite (8,669 psi) and the pine solid (10,024 psi). The average MOE of the solid alpine fir, pine-alpine fir composite, and the solid pine were 1,301,000 psi, 1,568,400 psi and 1,757,000 psi, respectively. The MOR of the solid alpine fir was 75.2% that of the pine-alpine fir composite, and that of the latter was 86.5% that of the solid pine. Likewise, the MOE of the solid alpine fir was 83.0% that of the pine fir composite, and that of the latter was 89.3% that of the solid pine.

TABLE 4
Strength properties of edge-bonded pine-alpine fir composite
compared to its solid members (Loaded on face without bondline).

| | Specimen | Modulus of Rupture | Modulus of Elasticity |
|---|---|---|---|
| Material | Number | (psi) | (psi) |
| Alpine fir | 1 | 6,872 | 1,242,000 |
| (solid) | 2 | 6,414 | 1,283,000 |
| | 3 | 6,194 | 1,404,000 |
| | 4 | 7,259 | 1,310,000 |
| | 5 | 5,877 | 1,266,000 |
| | Average | 6523 | 1301000 |
| Pine | 1 | 6.914 | 1,487,000 |
| (solid) | 2 | 13,780 | 2,133,000 |
| | 3 | 7,877 | 1,468,000 |
| | 4 | 10,130 | 1,877,000 |
| | 5 | 11,420 | 1,820,000 |
| | Average | 10024 | 1757000 |
| Pine- | 1 | 7,212 | 1,485,000 |
| Alpine fir | 2 | 8,171 | 1,540,000 |
| (composite) | 3 | 9,379 | 1,594,000 |
| | 4 | 9,509 | 1,539,000 |
| | 5 | 9,073 | 1,684,000 |
| | Average | 8669 | 1568400 |

Similarly, for the spruce-alpine fir combination (Table 5), the solid alpine fir also yielded the lowest average MOR (7,060 psi), followed by the spruce-alpine fir composite (8,061 psi) and the solid spruce (8,475 psi). The average MOE of the solid alpine fire, spruce-alpine fir composite, and the solid spruce were 1,214,000 psi, 1,543,200 psi, and 1,691,200 psi, respectively. The MOR of the solid alpine fir was 87.6% that of the spruce-alpine fir composite, and that of the latter 95.1% that of the solid spruce. Likewise, the MOE of the solid alpine fir was 78.7% that of the spruce-alpine fir composite, and that of the latter 91.2% that of the solid spruce.

TABLE 5
Strength properties of edge-bonded spruce-alpine fir composite
compared to its solid members (Loaded on face without bondline).

| | Specimen | Modulus of Rupture | Modulus of Elasticity |
|---|---|---|---|
| Material | Number | (psi) | (psi) |
| Alpine fir | 1 | 7,253 | 1,315,000 |
| (solid) | 2 | 6,887 | 1,187,000 |
| | 3 | 7,529 | 1,279,000 |
| | 4 | 7,043 | 1,211,000 |
| | 5 | 6,587 | 1,078,000 |
| | Average | 7060 | 1214000 |
| Spruce | 1 | 8,131 | 1,618,000 |
| (solid) | 2 | 7,083 | 1,558,000 |
| | 3 | 9,715 | 1,724,000 |
| | 4 | 8,247 | 1,549,000 |
| | 5 | 9,199 | 2,007,000 |
| | Average | 8475 | 1691200 |
| Spruce- | 1 | 7,672 | 1,518,000 |
| Alpine fir | 2 | 7,106 | 1,355,000 |
| (composite) | 3 | 9,145 | 1,542,000 |
| | 4 | 6,461 | 1,581,000 |
| | 5 | 9,920 | 1,720,000 |
| | Average | 8061 | 1543200 |

It appears that the composites (pine-alpine fir and spruce-alpine fir) developed strength characteristics significantly closer to those of the solid wood material with the higher strength properties (e or spruce) than that with the lower strengths (alpine fir). This is also graphically illustrated in FIG. 8 for the pine-alpine fir combination. The above results demonstrate the upgrading effect of the edge-bonding technology on the strength properties of the composite in relation of the member with the lower strengths.

### Example 4

Dimensional Stability of Post Products Prepared from Edge-bonded Wood Composite

An experiment was conducted to assess the warping properties of post products prepared from the edge-bonded wood composite. The materials used were the 1.25-inch-thick edge-bonded panels prepared in Example 2 above. Three of the panels were laminated together. The panels were lightly planed before laminating. The assembly was laid up in such a way that the edge joints of the adjacent panels were staggered. The assembly was cold pressed on a hydraulic press using a catalyzed polyvinyl acetate adhesive, and the specific pressure used for laminating was 125 psi. Three post specimens, 85×105×1524 mm, were prepared from the laminated sample. The MC of the post specimens was 10.1 to 12.4% with an average of 11.4%. The specimens were stored by hanging them vertically with an islet hook attached from one end.

The warping (bow, cup, twist, and crook) were measured three days after the specimens were made. The results are shown in Table 6 for the three-ply post specimens. No bow and cup were observed in the specimens. The twist ranged from 0.4 to 0.6 mm (average 0.5 mm) and the crook 0.0 to 0.5 mm (average 0.2 mm). These warping values were very small demonstrating further the positive effect of the new processing technology in imparting dimensional stability to the post product made from the edge-bonded wood composite.

TABLE 6
Dimensional stability of three-ply post products prepared
from the laminated new edge-bonded wood composites.

| Specimen | Bow | Cup | Twist | Crook |
|---|---|---|---|---|
| No. | (mm) | (mm) | (mm) | (mm) |
| 1 | 0.0 | 0.0 | 0.6 | 0.5 |
| 2 | 0.0 | 0.0 | 0.4 | 0.0 |
| 3 | 0.0 | 0.0 | 0.6 | 0.0 |
| Average | 0.0 | 0.0 | 0.5 | 0.2 |

While specific embodiments of the invention have been described and illustrated, such embodiments should be considered illustrative only, and not as limiting the invention as construed in accordance with the accompanying claims.

References Cited

1. CAN/CSA-0132.2 Series-90. 1990. Wood flush doors. National standards of Canada, Canadian Standards Association. Rexdale (Toronto), Ontario.

2. CSA 0132.5-M1992. Stile and rail wood doors. Building materials. Canadian Standards Association. Rexdale (Toronto), Ontario.

3. Grenier, R. 1999. Process for making a wood board and the wood board. U.S. Pat. No. 5,888,620. Cooperative Forestiere Laterriere, Laterriere, Canada.

4. Grenier, R. 2000. Process for making wood a board and the wood board. U.S. Pat. No. 6,025,053. CFL Structure Inc., Laterriere, Canada.

5. Hertel, J. E. 1983. Composite wood article and method of manufacture. U.S. Pat. No. 4,394,409. Weyerhaeuser Co., Tacoma, Wash.

6. Jessome, A. P. 1977. Strength and related properties of woods grown in Canada. Forestry Tech. Rep. 21, Ottawa, Ontario.

7. National Lumber Grades Authority. 1987. Standard Grading Rules for Canadian Lumber. Vancouver, B.C.

What is claimed is:

1. A method of making a composite wood product comprising joining complementary profiled side surfaces of two waney pieces of lumber, wherein each piece of lumber has been cut from a log, the log having growth rings concentrically arranged radially about a longitudinal axis of the log from an inner pith to an outer bark, so that the piece has a length substantially parallel to the longitudinal axis, a width substantially tangential to the growth rings and a thickness substantially perpendicular to the growth rings, with a top surface of the piece being towards the outer bark with respect to a bottom surface of the piece being towards the inner pith, the top surface and the bottom surface defining the thickness of the piece, and a left side surface and a right side surface defining the width of the piece, wherein at least one of the side surfaces of the piece is profiled to remove a wane to provide the complementary profiled side surface for joining; and, the pieces of lumber are joined in opposite orientation with the top surface of one piece adjacent to the bottom surface of the adjoining piece across the joined profiled side surfaces.

2. The method of claim 1, wherein the profiled side surface is rotationally self-complementary so that the profiled side surface would mate with itself when the piece is turned upside down.

3. The method of claim 1 or 2, wherein the width of the piece is greater than the thickness of the piece.

4. The method of any one of claims 1 through 3, wherein the profiled side surface comprises a series of right-angled steps disposed diagonally across the thickness of the piece.

5. The method of any one of claims 1 through 4, wherein the pieces of lumber are selected from more than one species of wood, whereby the composite wood product comprises a combination of wood species.

6. The method of claim 5, wherein the pieces of lumber are selected from among spruce, pine, and fir.

7. The method of claim 6, wherein the pieces of lumber are pine and alpine fir.

8. The method of claim 6, wherein the pieces of lumber are white spruce and alpine fir.

9. The method of any one of claims 1 through 8, wherein the pieces of lumber have an MC greater than 12 to 15%.

10. The method of claim 9, wherein the MC is less than 25%.

11. The method of any one of claims 1 through 10, wherein the pieces of lumber are bonded together with an adhesive.

12. A composite wood product made by the method of any one of claims 1 through 11.

13. A composite wood product comprising at least two pieces of waney lumber joined at complementary profiled side surfaces, wherein the composite wood product comprises at least two pieces of lumber, wherein each piece of lumber has been cut from a log, the log having growth rings concentrically arranged radially about a longitudinal axis of the log from an inner pith to an outer bark, so that each piece has a length substantially parallel to the longitudinal axis, a width substantially tangential to the growth rings and a thickness substantially perpendicular to the growth rings, with a top surface of the piece being towards the outer bark with respect to a bottom surface of the piece being towards the inner pith, the top surface and the bottom surface of each piece defining the thickness of the piece, and a left side surface and a right side surface of each piece defining the width of the piece, wherein at least one of the side surfaces of each piece is profiled to remove a wane to provide the complementary profiled side surfaces for joining the pieces; and, the pieces of lumber are joined in opposite orientation with the top surface of one piece adjacent to the bottom surface of the adjoining piece across the joined profiled side surfaces.

14. The composite wood product of claim 13, wherein the pieces of lumber are selected from more than one species of wood, whereby the composite wood product comprises a combination of wood species.

15. The composite wood product of claim 14, wherein the pieces of lumber are selected from among spruce, pine, and fir.

16. The composite wood product of claim 15, wherein the pieces of lumber are pine and alpine fir.

17. The composite wood product of claim 15, wherein the pieces of lumber are white spruce and alpine fir.

18. The composite wood product of any one of claims 13 through 17, wherein the pieces of lumber have an MC greater than 12 to 15%.

19. The composite wood product of claim 18, wherein the MC is less than 25%.

20. The composite wood product of any one of claims 13 through 19, wherein the pieces of lumber are bonded together with an adhesive.

21. A method of milling wood, comprising cutting a piece of lumber from a log, the log having growth rings concentrically arranged radially about a longitudinal axis of the log from an inner pith to an outer bark, so that the piece has a length substantially parallel to the longitudinal axis, a width substantially tangential to the growth rings and a thickness substantially perpendicular to the growth rings, with a top surface of the piece being towards the outer bark with respect to a bottom surface of the piece being towards the inner pith, the top surface and the bottom surface defining the thickness of the piece, and a left side of the piece and a right side of the piece defining the width of the piece, wherein at least one of the sides of the piece is profiled to remove a wane to provide a profiled side, and the profiled side comprises a series of right-angled steps disposed diagonally across the thickness of the piece.

22. The method of claim 21, wherein both side edges of the piece are profiled, and the profiles of the opposing sides of the piece are complementary.

23. A method of making a composite wood product comprising joining complementary profiled side edges of two pieces of lumber milled in accordance with the method of claim 21 or 22, wherein the pieces of lumber are joined in opposite orientation with the top surface of one piece adjacent to the bottom surface of the adjoining piece across the joined edges.

24. The method of claim 23, wherein the pieces of lumber are selected from more than one species of wood, whereby the composite wood product comprises a combination of wood species.

25. The method of claim 24, wherein the pieces of lumber are selected from among spruce, pine, and fir.

26. The method of claim 25, wherein the pieces of lumber are pine and alpine fir.

27. The method of claim 25, wherein the pieces of lumber are white spruce and alpine fir.

28. The method of any one of claims 23 through 27, wherein the pieces of lumber have an MC greater than 12 to 15%.

29. The method of claim 28, wherein the MC is less than 25%.

30. The method of any one of claims 23 through 29, wherein the pieces of lumber are bonded together with an adhesive.

31. A composite wood product made by the method of any one of claims 23 through 30.
